(19) United States
(12) Patent Application Publication
(10) Pub. No.: US 2010/0051742 A1
(43) Pub. Date: Mar. 4, 2010

(54) Folding Wing & Locking Mechanism

(75) Inventors: Samuel Adam Schweighart, Watertown, MA (US); Carl Curtis Dietrich, Woburn, MA (US); Andrew Heafitz, Cambridge, MA (US); Benjamin Zelnick, Cambridge, MA (US)

Correspondence Address: GOODWIN PROCTER LLP;PATENT ADMINISTRATOR, 53 STATE STREET, EXCHANGE PLACE, BOSTON, MA, 02109-2881, US

(73) Assignee: Terrafugia, Inc,;, Woburn, MA (US)

(21) Appl. No.: 12/177,849

(22) Filed: Jul. 22, 2008

(51) Int. Cl. B64C 3/56

(52) U.S. Cl. 244/49

(57) ABSTRACT

Improved mechanisms for folding and locking an aircraft wing and controlling the wing's aileron through a wing fold have been motivated by development of a roadable aircraft. Applicable to a broader class of aircraft, these mechanisms allow for a safer, lighter-weight solution to the wing-folding challenge than currently available. The cable control system allows an outer wing section to be moved in concert with an actuated inner wing section. The locking mechanism allows for automated operation and visual inspection. The aileron control mechanism provides centering and locking in addition to flight control through the hinge axis.

### FEDERALLY SPONSORED RESEARCH

Not Applicable

### SEQUENCE LISTING OR PROGRAM

Not Applicable

### FIELD OF THE INVENTION

This invention relates to aircraft and to roadable aircraft, a type of aircraft that can be converted into an automotive type vehicle capable of driving on the road, sometimes popularly referred to as a “flying car” or “flying-driving vehicle”. It is also relevant to applications involving hydrofoils (as distinct from airfoils).

### BACKGROUND OF THE INVENTION

This invention, though extensible to a broader spectrum of applications, was motivated by the development of a roadable aircraft. One of the challenges of developing a practical roadable aircraft is how to safely and securely stow the wings while operating in the road environment. Conveniently stowing any aircraft's wings for storage could be accomplished with the same or similar techniques. This invention represents an improved method for accomplishing this.

A common method for stowing the wings of a roadable aircraft described in prior art is to rotate the wings into an orientation parallel to the fuselage of the aircraft. This is the approach taken in broad terms by Geisse (U.S. Pat. No. 2,424,068), Spitzer (U.S. Pat. No. 6,082,665), Pellarini (U.S. Pat. No. 2,674,422), Pham (U.S. Pat. No. 5,984,228), and Bragg (U.S. Pat. No. 6,086,014), among others. Some of the prior art does combine a fold with this rotation. The bi-fold invention described here improves upon this technique by reducing the side area of the vehicle on the road, thus improving safety in high-wind conditions; and by protecting more of the flight surface against potential damage from road debris. Additionally, a bi-folding wing can have a greater span while still allowing the roadable configuration of the aircraft to fit in a standard automotive parking space.

The bi-fold invention described here has many of the same advantages over the single fold wing designs common in naval military aircraft, such as the invention of Naumann (U.S. Pat. No. 2,712,421). A prior bi-fold wing design has been proposed by Schertz (U.S. Pat. No. 3,371,886) in which the wing hinges at the top of the airfoil at both the root and at the mid-span. The invention described here improves upon Schertz in part by folding from the bottom of the airfoil. This results in a more compact design which requires less volume to actuate and that offers superior protection to the hinge in the root of the wing as it is not exposed to the ground.

Other prior methods include wings that combine rotation and folding mechanisms. An example of this style is seen in the concept put forth by Bragg (U.S. Pat. No. 6,086,014). The complicated nature of this combined style necessitates either manual operation or a heavier and more complicated actuation system than is put forth in this invention. Manual operation of the wing folding and unfolding process has proven to be commercially undesirable.

Any safe folding wing mechanism must also include a method by which the wings are secured in place in both its folded and deployed configurations. In the prior art, this is often accomplished through the use of locking pins. This method is seen in both military and roadable aircraft folding wing mechanisms. See Veile, (U.S. Pat. No. 5,558,229) and Spitzer, (U.S. Pat. No. 6,082,665) for an example of each. The invention described here is an improvement on previous wing locking techniques as it allows a quick, simple, direct visible and tactile check of the locking mechanism before flight by the pilot to ensure safe operation. The locking and unlocking mechanisms are activated by the same automated process as the wing folding and deployment, thus eliminating the need for secondary mechanisms. This is an improvement over inventions such as that described by Pham (U.S. Pat. No. 6,129,306) in which a pin is inserted for flight and a bungee cord is required to secure the wings when stowed. The wing locks described in this invention are an improvement over prior art in that they are both safer and more convenient than previous roadable aircraft locking mechanisms while being simpler and lighter weight than military wing locking devices.

The aileron control and locking mechanism put forth in this invention improves upon the prior art by simplifying the execution of both key functionalities. By using only a single torque tube which does not disconnect from the aircraft cockpit control, the invention described here presents fewer opportunities for failure during flight than does a mechanism with multiple linkages such as put forth by Byford (U.S. Pat. No. 4,778,129). Also, by locking the ailerons in their neutral position by centering and latching the flight control (which is not used on the road) before folding the wings, the invention presented here eliminates the need for secondary aileron locks, an example of which is put forth by Sheahan et al. (U.S. Pat. No. 7,322,545).

In broad terms, when used in the preferred embodiment, the invention presented here represents part of a more elegant and more commercially viable solution to the challenge of folding the wings on a roadable aircraft for ground use than those previously conceived.

### SUMMARY OF THE INVENTION

The invention covers improvements to the mid-wing hinge area of a bi-fold aircraft wing including a cable actuation system, locking mechanism and aileron control mechanism. While the preferred embodiment is the use of these mechanisms at the mid-span fold in a bi-fold wing for a roadable aircraft, aspects of this invention can be applied to single-fold and non-roadable applications.

A cable and pulley system is utilized to deploy the outer wing while the inner wing is also being deployed. One end of this cable is attached rigidly to the vehicle, travels through the inner wing, and is attached to a pulley in the outer wing section such that an axial motion of this cable causes a rotation of the outer wing pulley. This pulley is rigidly attached to the outer wing, resulting in a rotation of the outer wing segment with respect to the inner wing segment. Thus, deploying the inner wing section through suitable means of actuation will cause the outer wing to deploy simultaneously in a controlled fashion.

Another cable-pulley system is utilized for retracting the outer wing from the flight configuration to the folded configuration as the inner wing retracts. A pulley is mounted in the inner wing section such that it is free to rotate relative to the inner wing section. A linkage is connected from this pulley to a fixed part of the vehicle so that when the inner wing rotates, the pulley mounted in the inner wing also rotates. Another pulley is rigidly attached to the outer wing section. A cable is attached to the inner wing pulley and to the outer wing pulley in such a way as to cause the outer wing to retract in concert with the inner wing as a result of motion in the inner wing root hinge in relation to the fixed part of the vehicle.

The distance over which the retraction and extension cables are spanned can be adjusted with tensioner pulleys such that the final positions of the outer wing sections in both the folded and extended positions can be precisely and easily determined without disassembly of the wing mechanism.

In both the tension and retraction system, turnbuckles can be employed for gross adjustment of the cable lengths leaving the finer adjust for the tensioner pulleys.

The preferred embodiment of the mid-span locking mechanism is shown as a T-shaped locking lever attached to one wing section that is driven into a mating key-hole on the other by a push/pull cable. The lever and key-hole need not be this particular shape, though it is an advantageous one given the loading conditions present. This latch has a dual fail-safe component, utilizing a spring as well as the actuation cable, to keep the outer wing section locked in flight configuration. Another improvement embodied in this latch is the ability of the pilot to perform both a direct visual and direct tactile check on its being in the locked position during the course of a standard pre-flight inspection of the aircraft.

As control surfaces such as ailerons lie on the outer wing, a method of transferring control moments must be created. In the preferred embodiment, control moments are transmitted through the wing sections using torque tubes. At the wing hinge, the torque tubes are connected using a hinge-type mechanism. The folding axis of this mechanism roughly aligns with the wing fold axis when the control surfaces is placed in a predetermined (typically neutral) position. When the wing is folded, the geometry of the mechanism prevents the rotation of the control surface essentially locking it into position. When the wing is deployed, the axis of the two torque tubes are aligned and control moments can be transmitted from one torque tube to the other. The benefits of such a mechanism are that control surface is never disconnected, thus reducing the changes for failure, and the same mechanism also locks the control surface in place when the wings are folded, thus removing the need for a secondary control surface lock.

### BRIEF DESCRIPTION OF THE DRAWINGS

FIG. 1 is a schematic cross-sectional side view of the wing cable and locking mechanism.

FIG. 2 is a schematic cut-away perspective view of a mid-span wing fold locking mechanism.

FIG. 3 is a schematic perspective view of a hinge in an aileron torque tube.

### NUMBERED COMPONENTS IN THE DRAWINGS

5. Hinge Link No. 1
6. Hinge Link No. 2
7. Hinge Link No. 3
8. Hinge Link No. 4
9. Lower Hinge Base
10. Lower Hinge Wing Side
11. Lower Hinge Pin
12. Upper Hinge Pin No. 1
13. Upper Hinge Pin No. 2
14. Upper Hinge Pin No. 3
15. Cable Anchor
16. Wing Retract Link
17. Wing Retract Pulley
18. Pulley Mount
19. Extension Cable
20. Retraction Cable
21. Tensioner Pulley
22. Adjustable Tensioner mount
23. Outer wing Pulley
24. Aircraft Body
40. Input Torque Tube
41. Input Hinge
42. Output Hinge
43. Output Torque Tube
44. Hinge Pin
45. Mid Position
46. Folded Position
50. Inner Wing
51. Outer Wing
52. Inner Wing Latch Mount
53. Outer Wing Latch Mount
54. Lever
55. Lever pin
56. Mid wing pivot
57. Spring
58. Step
59. Actuation Cable
60. Face
61. Face
62. Lever Head
63. Lever Opposing Face

### DETAILED DESCRIPTION OF THE INVENTION

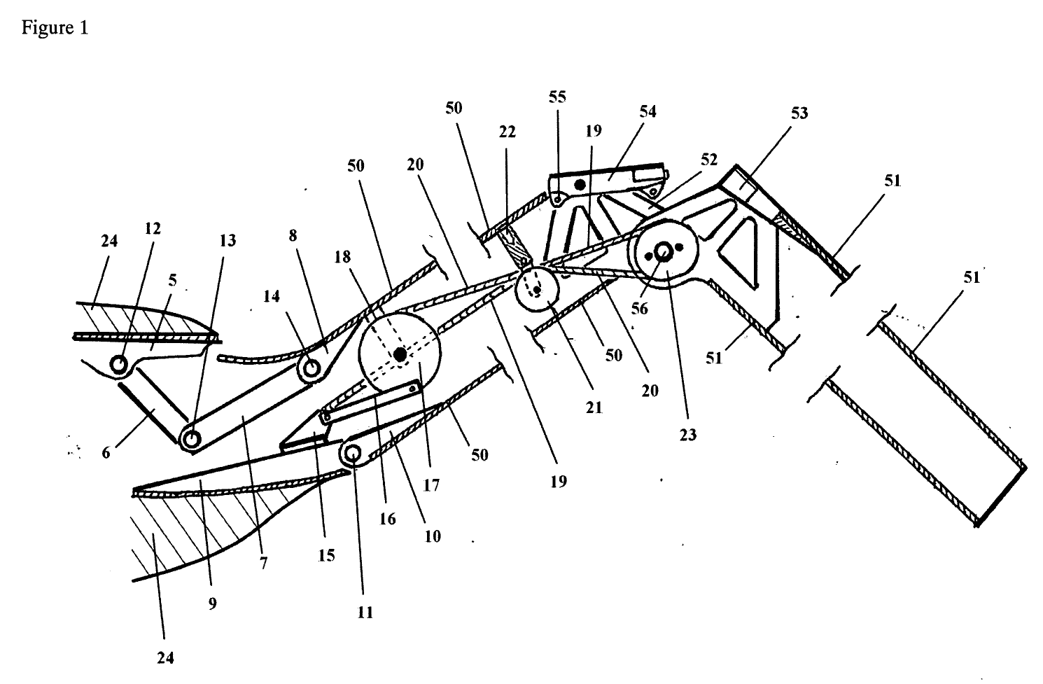

FIG. 1 shows the preferred embodiment for the cable actuation of the outer wing. The inner wing (50) is attached to the aircraft body (24), and the outer wing (51) is attached to the inner wing (50) as follows: hinge link no. 1 (5) and lower hinge base (9) are mounted in a fixed manner to the body (24). The inner wing (50) is attached to the lower hinge wing side (10) and hinge link no. 4 (8) and then pivots in relation to the body (24) via the lower hinge pin (11). The inner wing (50) is driven to rotate by the linkage comprising hinge link no. 1 (5), hinge link no. 2 (6), hinge link no. 3 (7), hinge link no. 4 (8), upper hinge pin no. 1 (12), upper hinge pin no. 2 (13) and upper hinge pin no. 3 (14). The outer wing (51) is attached to the inner wing (50) via the outer wing latch mount (53) and the inner wing latch mount (52) respectively and (53) and (52) are allowed to rotate about the mid wing pivot (56). The actuation cable system is installed in the wing mechanism as follows: cable anchor (15) is rigidly attached to lower hinge base (9), and extension cable (19) is fixed to cable anchor (15). Extensioner cable (19) runs over tensioner pulley (21), which is attached to the inner wing (50) via the adjustable tensioner mount (22). The adjustable tensioner mount (22) is an adjustable member which can change the distance between the center of tensioner pulley (21) and the upper skin of the inner wing (50). The extension cable (19) then continues on to the outer wing pulley (23), which has a track for the extension cable (19) to run in, and a fixed point for the end of (19) to terminate rigidly in such a manner that the end of (19) cannot move in relation to (23). The extension cable (19) can wrap and unwrap around the outer wing pulley (23) as said (23) rotates in relation to the inner wing (50). The outer wing pulley (23) is rigidly attached to the outer wing latch receiver (53), and (23) moves in fixed relation to the outer wing (51).

The retraction cable system is installed in the wing mechanism as follows: the wing retract pulley (17) is mounted to the pulley mount (18) so that it can rotate freely. Pulley mount (18) is rigidly fixed to the inner wing (50). The wing retract pulley (17) can be caused to rotate when force is exerted by the wing retract link (16), which is attached to (17) with a pivot. The wing retract link (16) is attached via pivot to cable anchor (15), which is rigidly fixed to lower hinge base (9). Retraction cable (20) is wrapped around wing retract pulley (17) in a channel on (17) so (20) can wind and unwind as (17) rotates. The end of retraction cable (20) is rigidly affixed to retract pulley (17) so that (20) cannot slip in relation to (17). Retraction cable (20) runs over tensioner pulley (21), which is attached to the inner wing (50) via adjustable tensioner mount (22), which is an adjustable member which can change the distance between the center of the tensioner pulley (21) and the upper skin of the inner wing (50). As shown in FIG. 1, tensioner pulley (21) is used to adjust extension cable (19). In the preferred embodiment, another pulley similar to tensioner pulley (21) is mounted in the same adjustable manner is used to adjust retraction cable (20), while (21) and adjustable tensioner mount (22) are used to adjust extension cable (19). In this manner, the tensions in the extension cable (19) and the retraction cable (20) are independently adjustable. Retraction cable (20) then continues on to outer wing pulley (23), which has a track for retraction cable (20) to run in, and a fixed point for the end of (20) to terminate rigidly in such a manner that the end of (20) cannot move in relation to (23), but (20) can wrap and unwrap around (23) as said (23) rotates in relation to the inner wing (50). The track in the outer wing pulley (23) in which the retraction cable (20) runs is separate from the track in the outer wing pulley (23) in which the extension cable (19) runs in order to avoid interference between (19) and (20) as (23) rotates. Outer wing pulley (23) is rigidly attached to outer wing latch receiver (53), and (23) moves in fixed relation to the outer wing (51).

The operation of the extension cable system works as follows: when the inner wing (50) is actuated to move into the deployed condition, (50) rotates clockwise about the lower hinge pin (11) with respect to the aircraft body (24). Because extension cable (19) is mounted rigidly to cable anchor (15) at a point displaced from the axis of lower hinge pin (11), when the inner wing (50) rotates about (11), (19) moves axially in relation to (50). The rotational axis of the outer wing pulley (23) is fixed in relation to the inner wing latch mount (52), and therefore the inner wing (50), so that the relative motion of the extension cable (19) causes the outer wing pulley (23) to rotate about the mid wing pivot (56) in a counterclockwise manner. Since the outer wing pulley (23) is affixed to the outer wing (51), said outer wing deploys as the inner wing (50) is moved into its deployed position.

The operation of the retraction cable system works as follows: when the inner wing (50) is actuated to move into the retracted condition, (50) rotates counterclockwise about the lower hinge pin (11) with respect to the aircraft body (24). Because the wing retract link (16) is mounted with a pivot to the cable anchor (15) at a point displaced from the axis of the lower hinge pin (11), when the inner wing (50) rotates about (11), (16) moves axially in relation to (50). The relative motion of the wing retract link (16), causes the wing retract pulley (17) to rotate in a counterclockwise manner about its axis mounted in the pulley mount (18). The counterclockwise rotation of the wing retract pulley (17) with respect to the inner wing (50), pulls on the retraction cable (20) which causes the outer wing pulley (23) to rotate about the mid wing pivot (56) in a clockwise manner. Since the outer wing pulley (23) is affixed to the outer wing (51), said outer wing retracts as the inner wing (50) is moved into its retracted position.

The tensioner pulley (21) can be adjusted by turning a screw contained in the adjustable tensioner mount (22). As the position of the tensioner pulley (21) moves towards or away from the outer wing skin of the inner wing (50), the paths of the extension cable (19) is lengthened or shortened. This increases tension in (19), and causes the outer wing pulley (23) to rotate slightly. Adjustment of the tensioner pulley (21) can be used to fine tune the position of the outer wing (51) with respect to the inner wing (50) prior to use, so that the ending positions of (51) after the extension phase is complete is properly aligned with (50). In the preferred embodiment, a similar adjustment pulley is used to provide the same adjustment ability for the retraction cable (20) during the retraction phase.

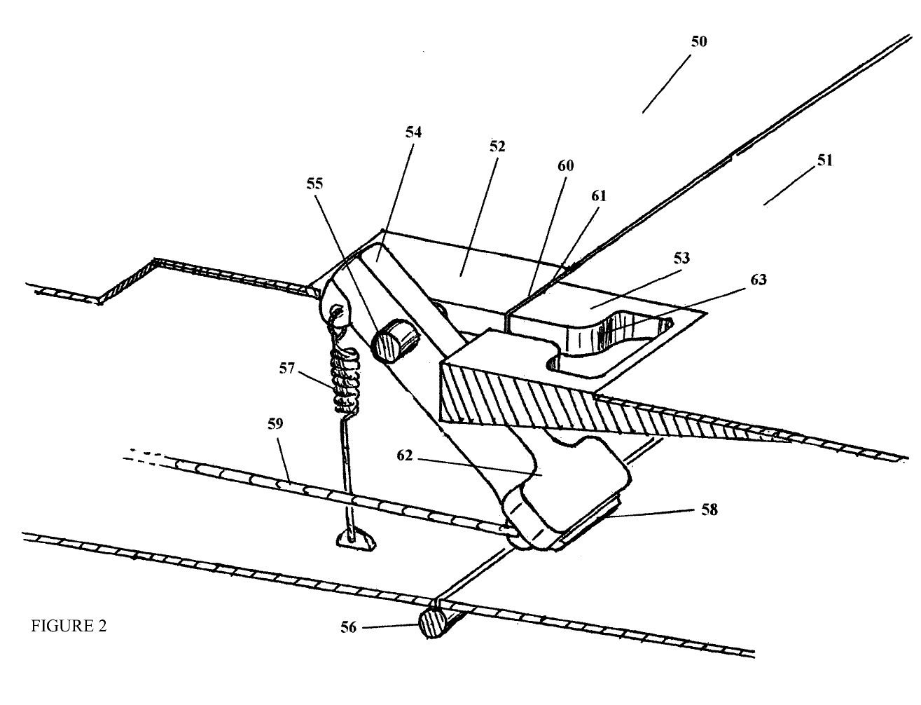

FIG. 2 shows the mid-span wing fold lock mechanism. In the preferred embodiment, the inner wing (50) is hinged with respect to the outer wing (51) through the axis of the mid wing pivot (56). The locking mechanism is mounted on the opposite wing surface from the mid wing pivot (56) axis. In the preferred embodiment, the mid wing pivot (56) is located near the bottom wing surface, and the locking mechanism is located on the top wing surface, although these positions could be changed as long as the locking mechanism is displaced radially from the pivot axis. The locking mechanism is housed in the inner wing latch mount (52) and the outer wing latch receiver (53). The lever (54), is attached to inner wing latch mount (52) via lever pin (55), and can pivot up to engage the outer wing latch receiver (53). The surfaces of the lever head (62) and of the lever opposing face (63) engage to hold the inner wing (50) and the outer wing (51) together. The step (58) in the lever (54) prevents said lever from passing through the outer wing latch receiver (53). The lever (54) has a hole at the end near lever pin (55) to allow attachment of a biasing device such as spring (57). At the opposite end, lever (54) has another hole to allow attachment of actuation cable (59). The inner wing latch mount (52) and the outer wing latch mount (53) also have contact areas faces (60) and (61).

The operation of the lever (54) is as follows: When the wing is moves to its extended position, by rotating about mid wing pivot (56), inner wing latch mount (52) and outer wing latch receiver (53) come together until face (60) and face (61) contact and stop the wing's rotational motion. Faces (60) and (61) may be padded with an elastomeric or other cushioned material to reduce the shock when the wing stops. Once the wing is in the extended position, actuation cable (59) is released, which allows spring (57) to pull on lever (54) and rotate (54) around lever pin (55). The head of lever (54) engages in a similar shaped recess in outer wing latch receiver (53), bringing locking faces of the lever head (62) and the lever opposing face (63) into contact with each other. Since the lever head (62) and the lever opposing face (63) are oriented or have a component of their direction which is tangent to the wing motion about the mid wing pivot (56), they serve to lock the outer wing (51) in place with respect to the inner wing (50) and prevent the wing from folding as long as the lever (54) is engaged in the outer wing latch receiver (53). Step (58) is a feature on lever (54) which engages with a similarly shaped receptacle in outer wing latch receiver (53), and prevents (54) from overshooting its locked position in (53). In the locked position, in the preferred embodiment, the top surface of lever (54) is flush with the top surfaces of outer wing latch receiver (53) and inner wing latch mount (52) allowing smooth airflow over the inner wing (50) and the outer wing (51), and providing a visual and tactile indication that said wing panels are securely locked together. The lever (54) is directly visible, and no other device such as a sensor, window or indicator is required, although such devices could be added. In the unlocked position, part of lever (54) penetrates the surface plane of the inner wing (50), allowing a visual and tactile indicator that the wings are in an unlocked state. The sides of lever (54) may be painted a warning color such as red to enhance the visual indication of the unlocked state.

To unlock and re-fold the inner wing (50) and the outer wing (51), actuation cable (59) is pulled. In the preferred embodiment, actuation cable (59) is a cable that runs to a control lever in the cockpit, although (59) could be actuated by other means such as electrically, hydraulically etc., or (59) could be an actuator connected directly to lever (54). Actuation cable (59) provides more torque to lever (54) than to spring (57), causing (54) to rotate around lever pin (55) and disengage from outer wing latch receiver (53). Once lever head (62) and lever opposing face (63) are no longer engaged, inner wing latch mount (52) and outer wing latch receiver (53) are free to separate and the inner wing (50) and the outer wing (51) can rotate about the mid wing pivot (56) to move into the folded position. It should be observed that since the actuation cable (59) and the spring (57) are attached in the positions that they are, a break or failure in (59) will allow (57) to continue pulling lever (54) into the locked position: incase (59) fails the wing will remain locked in flight-capable configuration. In the preferred embodiment, actuation cable (59) is a push-pull cable, so in the event that spring (57) fails, lever (54) is still held in place. The double redundancy provides an extra level of safety when the wing is in use.

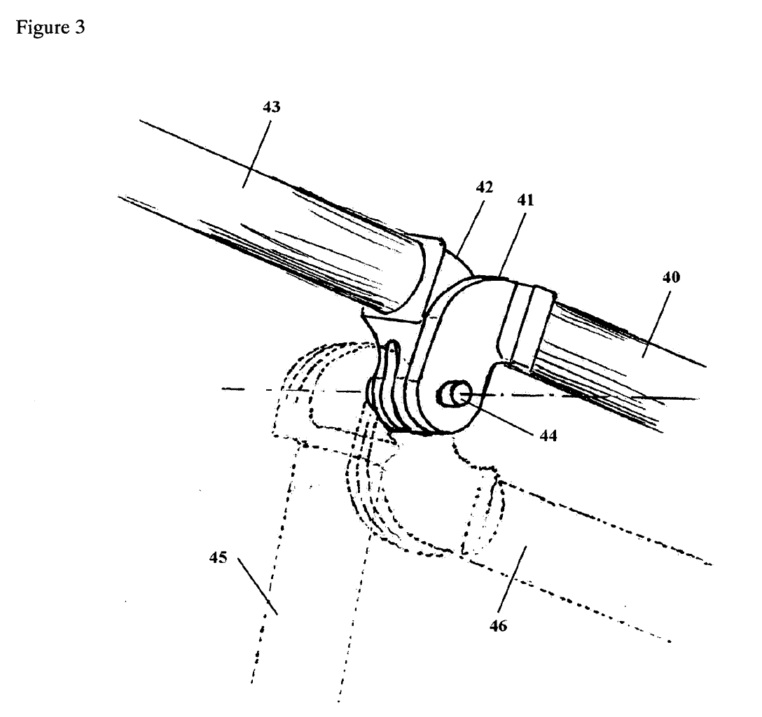

FIG. 3 shows the folding torque tube used to actuate the aileron in the preferred embodiment of the folding wing mechanism. This joint is located between the inner (50) and outer (51) wings in FIG. 3. The input torque tube (40) which is made of carbon fiber or other stiff material, is rigidly attached to the input hinge (41). The input hinge (41) and the output hinge (42) are allowed to pivot about the hinge pin (44), which is in line with the hinging axis of the wing. Output torque tube (43) is rigidly attached to output hinge (42). When the wing is folded, output torque tube (43) passes through mid position (45) and stops at folded position (46) when the wings are completely folded.

When the wings are in the open position, the output torque tube (43) and input torque tube (40) are collinear. Any rotational movement or force imparted by the input torque tube (40) goes through the hinge assembly and rotates or provides a force on the output torque tube (43), which transmits it to the aileron. In the preferred embodiment, the aileron is free to be moved by a mechanism linked to the control stick in the vehicle cockpit. When the wings are to be folded, the input torque tube (40) is moved to the center rotational position, so that the hinge pin (44) significantly aligns with the hinge axis of the inner and outer wing. The hinge is self centering over small angles, so small errors in alignment will be self correcting. Once the wing folds, the output torque tube (43) will move to the folded position (46). In this position the aileron will be held rigidly in the center position, and the control stick will also be held rigidly in the center position.

When the wings are unfolded said torque tubes realign and are again free to rotate about their longitudinal axes.

We claim:

1) A bi-fold wing mechanism which provides relative rotation of an outer wing section to an inner wing section when said inner wing section rotates relative to a vehicle comprising:
a) said vehicle,
b) said inner wing section,
c) an inner wing hinge connecting said inner wing section to said vehicle,
d) said outer wing section,
e) an outer wing hinge connecting said outer wing section to said inner wing section,
f) a means for converting rotational motion of said inner wing relative to said vehicle to rotational motion of said outer wing relative to said inner wing
whereby said outer wing rotates when said inner wing rotates.

2) A bi-fold wing mechanism which provides relative rotation of an outer wing section to an inner wing section when said inner wing section rotates relative to a vehicle comprising:
a) said vehicle,
b) said inner wing section,
c) an inner wing hinge connecting said inner wing section to said vehicle,
d) said outer wing section,
e) an outer wing hinge connecting said outer wing section to said inner wing section,
f) a first means for deploying said outer wing section when said inner wing section deploys,
g) a second means for stowing said outer wing section when said inner wing section stows.

3) The mechanism in claim 2 wherein said first means and said second means are accomplished with one device.

4) The mechanism in claim 2 wherein said second means is comprised of a spring, bungie, gravity, or any other similar means that apply a biasing force or torque on said outer wing in an direction opposite of the force or torque applied by said first means.

5) The mechanism in claim 2 wherein said first means, said second means, or both said first means and said second means are comprised of:
a) a cable or similar transmitter of linear motion,
b) said cable connected at one end to said vehicle at a predetermined location, whereby said cable moves relative to said inner wing when said inner wing rotates relative to said vehicle,
c) a pulley, or similar converter of linear motion to rotational motion,
d) said pulley connected to said outer wing whereby rotational motion of said pulley is transmitted to said outer wing.
e) said cable connected to said pulley
f) whereby when said inner wing moves relative to said vehicle, said mechanism causes said outer wing to rotate.

6) The mechanism in claim 5 wherein said cable is a rod, chain, belt, push-pull cable, or similar device.

7) The mechanism in claim 5 wherein said pulley is a cam, offset pulley, linkage, lever, mounting location on said outer wing, or similar converter of linear motion to rotational motion.

8) The mechanism in claim 2 wherein said first means and/or said second means is comprised of:
a) a linkage connected on one end to said vehicle,
b) a first pulley with an axis of rotation fixed relative to said inner wing,
c) a connection between said linkage and said first pulley whereby when said inner wing rotates relative to said vehicle, said linkage causes said first pulley to rotate with respect to said inner wing,
d) a first cable or similar transmitter of linear motion,
e) a connection between said first cable and said first pulley,
f) a second pulley, or similar converter of linear motion to rotational motion,
g) a connection between said second pulley and said outer wing whereby rotational motion of said second pulley is transmitted to said outer wing,
h) a connection between said first cable and said second pulley,
whereby when said inner wing rotates relative to said vehicle, said mechanism causes said outer wing to rotate with respect to said inner wing.

9) The mechanism in claim 8 wherein said cable is a rod, chain, belt, push-pull cable, or similar device.

10) The mechanism in claim 8 wherein said pulleys are cams, offset pulleys, linkages, levers, cable mounting location on said outer wing, similar converter of linear motion to rotational motion, or some combination thereof.

11) The mechanism in claim 8 wherein said mechanism includes:
a) a second cable or similar transmitter of linear motion,
b) a connection between said second cable and said first pulley, whereby said second cable moves relative to said inner wing when said inner wing rotates relative to said vehicle,
c) a third means for converting linear force from said second cable into rotational motion of said outer wing
whereby both said first cable and said second cable provide the means for rotating said outer wing in either direction.

12) The mechanism in claim 11 wherein said cables are rods, chains, belts, push-pull cables, similar device or some combination thereof.

13) The mechanism in claim 11 wherein said pulleys are cams, offset pulleys, linkages, levers, mounting location on said outer wing, similar converter of linear motion to rotational motion, or some combination thereof.

14) The mechanism in claim 11 wherein said mechanism includes a connection between said second cable and said second pulley whereby tension in said second cable causes said outer wing to rotate in a direction opposite to the direction said outer wing rotates when tension is applied to said first cable.

15) The mechanism in claim 11 wherein said cables are replaced by a singular belt or a plurality of belts or other transmitters of rotational motion.

16) The mechanism in claim 11 wherein said cables are replaced by a singular cable or a plurality of cables of other transmitters of linear motion.

17) The mechanism in claim 11 wherein said third means comprises of:
a) a third pulley
b) said third pulley connected to said outer wing whereby rotational motion of said pulley is transmitted to said outer wing,
c) a connection between said second cable and said third pulley
whereby tension in said second cable causes said outer wing to rotate in a direction opposite to the direction said outer wing rotates when tension is applied to said first cable.

18) The mechanism in claim 17 wherein said pulleys are cams, offset pulleys, linkages, levers, cable mounts on said outer wing, similar converter of linear motion to rotational motion, or some combination thereof.

19) The mechanism in claim 2 wherein
a) said first means is comprised of:
i) a linkage connected on one end to said vehicle,
ii) a first pulley with an axis of rotation fixed relative to said inner wing,
iii) a connection between said linkage and said pulley whereby when said inner wing rotates relative to said vehicle, said linkage causes said pulley to rotate with respect to said inner wing,
iv) a first cable or similar transmitter of linear motion,
v) a connection between said first cable and said first pulley, whereby said first cable moves relative to said inner wing when said inner wing rotates relative to said vehicle,
vi) a second pulley,
vii) a connection between said second pulley to said outer wing whereby rotational motion of said second pulley is transmitted to said outer wing,
viii) said first cable connected to said second pulley,
whereby when said inner wing moves relative to said vehicle, said outer wing rotates with respect to said inner wing.
b) said second means is comprised of:
i) a second cable or similar transmitter of linear motion,
ii) said second cable connected at one end to said vehicle at a predetermined location, whereby said second cable moves relative to said inner wing when said inner wing rotates relative to said vehicle,
iii) a third pulley, or similar converter of linear motion to rotational motion,
iv) said third pulley connected to said outer wing whereby rotational motion of said third pulley is transmitted to said outer wing.
v) said second cable connected to said third pulley whereby when said inner wing moves relative to said vehicle, said outer wing rotates with respect to said inner wing.

20) The mechanism in claim 19 wherein said cables are rods, chains, belts, push-pull cables, similar device or some combination thereof.

21) The mechanism in claim 19 wherein said pulleys are cams, offset pulleys, linkages, levers, mounting location on said outer wing, similar converter of linear motion to rotational motion, or some combination thereof.

22) The mechanism in claim 2 wherein:
a) said first, said second means is comprised of a cable, belt, chain or similar device for transmitting linear motion,
b) said mechanism includes adjustment means for changing the path, length, tension or combination thereof of said cable or cables.

23) The mechanism in claim 22 wherein:
a) said adjustment means is a pulley, cam, sprocket, slide, turnbuckle or other device in contact with said cable,
b) said adjustment means has a variable position or orientation whereby the path, tension, length or combination thereof of said cable are adjusted.

24) The mechanism in claim 22 wherein the location or orientation of said adjustment means can be adjusted from outside the wing whereby the rotational orientation of said outer wing can be adjusted easily without disassembly of said mechanism.

25) A wing-fold lock mechanism comprising:
a. a wing,
b. a body,
c. a hinge comprising of a first hinge half connected to said wing and a second hinge half connected to said body,
d. a first mechanical stop located on said wing,
e. a second mechanical stop located on said body,
f. a locking device that prevents one of said mechanical stops from moving away from said opposing mechanical stop
whereby a combination of said mechanical stops and said locking mechanism prevent said wing from moving with respect to said body when said locking device is engaged.

26) The mechanism in claim 25 wherein said locking device is a lever comprising:
a) a pivot axis located in one of said mechanical stops about which said lever pivots,
b) an interlocking shape that interfaces with a corresponding recess in said opposing mechanical stop.

27) The mechanism in claim 26 wherein said hinge is located on the lower side of said wing, and said first mechanical stop is located on the top side of said wing.

28) The mechanism in claim 26 wherein said lever is shaped like the capital letter T, or the capital letter L, or any shape that prevents said first mechanical stop from moving with respect to said second mechanical stop.

29) The mechanism in claim 26 wherein said lever comes flush or nearly so with the outer surface of either or both said mechanical stops whereby said lever can be easily inspected to ensure that said lever is completely locked, and smooth airflow is maintained over the wing.

30) The mechanism in claim 26 wherein said mechanism includes means for returning said lever to the locked position.

31) The mechanism in claim 30 wherein said means is accomplished using a spring, bungie cord, electrical actuator, cable, rod, or any method that actively or passively returns said lever into the locked position.

32) The mechanism in claim 26 wherein said mechanism comprises of means for returning said lever to the unlocked position.

33) The mechanism in claim 32 wherein said means is accomplished using a spring, bungie cord, electrical actuator, cable, rod, or any method that actively or passively returns said lever into the unlocked position.

34) The mechanism in claim 26 wherein said lever has colored components only visible in the unlocked position to aid visual identification of an unlocked state.

35) A mechanism for articulating a control surface through a folding wing joint comprising:
a) a wing assembly comprising:
i) an inner wing section or body,
ii) an outer wing section that folds with respect to said first wing section,
b) a first torque tube located adjacent to or inside said inner wing section,
c) a second torque tube located adjacent to or inside said outer wing section,
d) a hinge that:
i) connects said first torque tube with said second torque tube,
ii) has an axis of rotation that is substantially collinear with the axis of rotation between said inner and said outer wing section when said control surface is placed in a predetermined orientation with respect to said outer wing section,
e) a first means for attaching said second torque tube to said control surface,
f) a second means for controlling the axial orientation of said first torque tube whereby said aileron will be controlled during flight
whereby said wing can be folded without the need for disconnecting said aileron, also said aileron is automatically held in a predetermined orientation when said wing is folded, and said mechanism transmits toque thereby controlling said aileron when wings are unfolded.

36) The mechanism in claim 35 wherein said mechanism includes a third means for ensuring said control surface is placed in a predetermined orientation before folding said wing.

37) The mechanism in claim 36 wherein said third means is comprised of:
a) a control stick, yoke, or any similar device,
b) a lock that holds said control stick in a predetermined position whereby said control surface is held in a predetermined orientation.

38) The mechanism in claim 35 wherein said hinge's axis of rotation is substantially perpendicular to, but not necessary intersecting, the axis of rotation of said torque tubes whereby when a torque is applied to said torque tubes, there is no resulting force attempting to fold or unfold said hinge.
